(19) United States
(12) Patent Application Publication
(10) Pub. No.: US 2022/0011201 A1
(43) Pub. Date: Jan. 13, 2022

(54) METHOD AND AN APPARATUS FOR DETERMINING ISOTOPE RELATIONSHIPS

(71) Applicant: ELEMENTAR ANALYSENSYSTEME GMBH, Langenselbold (DE)

(72) Inventors: Oliver WÜRFEL, Seligenstadt (DE); Hans Joachim KUPKA, Neuberg (DE)

(21) Appl. No.: 17/281,924

(22) PCT Filed: Dec. 10, 2019
(86) PCT No.: PCT/EP2019/084331

§ 371 Date: Mar. 31, 2021

(30) Foreign Application Priority Data
Dec. 13, 2018 (DE) 10 2018 132 124.4

(51) Int. Cl. G01N 1/40; G01N 30/72; G01N 30/84; G01N 30/88

(52) U.S. Cl. CPC G01N 1/4044; G01N 30/7233; G01N 30/84; G01N 2030/8868; G01N 2030/8405; G01N 2030/8447; G01N 30/88

(57) ABSTRACT

The invention relates to a method and the device which is required for its performing for the determination of the isotope ratio of carbon and/or nitrogen in an aqueous mobile phase which contains a sample. The method comprises the following steps: introduction of the aqueous mobile phase into a reactor (i), heating of the aqueous mobile phase with addition of oxygen in the reactor to a temperature of higher than 600° C. for the formation of a water containing sample gas (ii), reduction of the nitrogen oxides being present in the sample gas as well as removal of the contained oxygen (iii), removal of water from the sample gas by chemical drying and/or membrane gas drying (iv) and introduction of the dried sample gas into an isotope mass spectrometer (v). It is essential for the present invention that the introduction in step (i) is realized by introducing the aqueous mobile phase in a capillary tube which leads into the reactor with a gas mixture of oxygen and at least one inert gas, wherein the mass flow of oxygen and inert gas is regulated or controlled by at least one mass flow controller which is upstream with respect to the introduction and that after step (iv) removed water is actively pumped off.

The invention relates to a method and a device for the determination of the isotope ratio of carbon and/or nitrogen in an aqueous mobile phase which contains a sample, comprising the following steps: (i) introduction of the aqueous mobile phase into a reactor, (ii) heating of the aqueous solution with addition of oxygen in the reactor to a temperature of higher than 600° C. for the formation of a water containing sample gas, (iii) reduction of the nitrogen oxides being contained in the sample gas as well as removal of the oxygen, (iv) removal of water from the sample gas by chemical drying and/or membrane gas drying and (v) introduction of the dried sample gas into an isotope mass spectrometer.

The isotopes of an element differ in their neutron and mass numbers. Here, the isotope ratio or the so-called isotope signature of a chemical element means the relative frequency of the isotopes of this element. For example, with the determination of the ratios of the stable isotopes of hydrogen, oxygen, carbon and nitrogen it is possible to determine the origin of plant and animal products.

For performing of the isotope ratio analysis highly precise mass spectrometers are used. Into them gaseous substances have to be fed. Here, on the one hand, bulk analyses for the determination of the isotope ratio in the whole sample are possible. In the article “A novel tool for stable nitrogen isotope analysis in aqueous samples” of E. Federherr et al., in Rapid Communication in Mass Spectrometry, 2016, 30, page 2537-2544 an example for this method can be found. For being able to individually characterize each single substance, on the other hand, there is the possibility to measure each substance separately. For this purpose, it is possible to temporally separate the single constituents of liquids by way of separating columns by means of liquid chromatography (LC). Continuously, the LC eluate after introducing into a reactor through combustion at a temperature of higher than 600° C. is reacted into gas.

So, the contained carbon as well as nitrogen compounds also react to gases and can be detected after a gas preparation with an isotope ratio mass spectrometer. Such a method is described, for example, in the article “A novel high temperature combustion interface for compound-specific stable isotope analysis of carbon and nitrogen via high-performance liquid chromatography/isotope ratio mass spectrometry” of E. Federherr et al., in Rapid Communication in Mass Spectrometry, 2016, 30, page 944 to 952.

When elemental analyzers are used, often the MFC is directly positioned before the detector, whereby the flow into the detector should be kept as constant as possible. This arrangement results in the disadvantage that it is possible that the mass flow controller due to water which is contained in the sample gas is damaged, when the water separation is insufficient or when a failure, e.g. an overflow of the condenser, occurs. In addition, when the introduction of the mobile phase is started or through a non-uniform sample feed, by the abrupt pressure increase a condensation in the supply lines of the system may take place. This is in particularly the case, when due to the detection sensitivity in the system no buffer volume is provided and the carrier gas flow is reduced.

In the article “A novel high temperature combustion interface for compound-specific stable isotope analysis of carbon and nitrogen via high-performance liquid chromatography/isotope ratio mass spectrometry” of E. Federherr et al., in Rapid Communication in Mass Spectrometry, 2016, 30, page 944 to 952 both mass flow controllers were positioned before the sample application.

In the case of this arrangement, because of the missing flow stabilization, finally a particularly uniform sample feed is essential. For this purpose, the sample is introduced by means of a capillary tube which should produce a jet. However, this is only successful, when the flow rates of the mobile phase are sufficiently high, because otherwise drops are formed. However, for some applications, these flow rates are above the flow rate which is optimal for the chromatographic separation. A small inner diameter of the capillary tube would allow a reduction of the flow of the mobile phase, but this would result in a too high back pressure which may damage the packing of some separating columns.

Furthermore, from the described configuration follows that the condenser after each completed measurement is discontinuously emptied by opening a valve which is arranged downstream with respect to the condenser and by releasing the system pressure along with the condensed water. After each measurement the pressure again has to be built up so that the possible measuring frequency decreases. The condenser must have a volume which is large enough for being able to collect a sufficiently large amount of water, and through the large dead volume the condenser results in a peak broadening during a continuous measuring operation without focusing.

Therefore, it is an object of the present invention to provide a method with which the isotope ratios of carbon and/or nitrogen in an aqueous solution can reliably be determined and at the same time an impairment of the plant, in particular of its mass flow controller, and at the same time also an impairment of the measurement by water can reliably be avoided.

This object is solved by a method with the features of patent claim 1.

Such a method, in principle, comprises the steps of:

(i) introduction of the sample in an aqueous mobile phase into a reactor,

(ii) heating of the aqueous solution with addition of oxygen in the reactor to a temperature of higher than 600° C., preferably higher than 800° C., particularly preferably to a temperature range of between 880 and 1150° C. for the formation of a water containing sample gas,

(iii) reduction of the nitrogen oxides being present in the sample gas as well as removal of the contained oxygen,

(iv) removal of water from the sample gas by chemical drying and/or membrane gas drying,

(v) introduction of the dried sample gas into an isotope mass spectrometer.

Essential for this method is that the introduction of the aqueous solution in step (i) is realized by leading the aqueous solution with water as mobile phase into the reactor by way of a capillary tube. Within this capillary tube a gas mixture of oxygen and at least one inert gas is fed such that the aqueous solution is atomized. So, due to this atomization and/or introduction in the form of very small drops can be guaranteed that the sample solutions also in the case of a low flow rate of the mobile phase in fact absolutely uniform enter the reactor and that thus pressure pulses are avoided.

In the synopsis, this changed arrangement also allows that by the more uniform feed the mass flow controller(s) for inert gas and/or oxygen is/are already arranged before the introduction into the reactor and so is/are protected against damages by water in downstream process steps. In addition, a shift of the mass flow controller(s) results in the advantage that an undesired condensation in supply lines and instabilities of the base line of the mass spectrometer can be avoided. Here, oxygen and inert gas have an effect which is comparable to an atomizer gas.

For reliably removing water completely it has been shown to be advantageous, when after the drying according to step (iv) removed water is actively pumped off. So, an increase of a liquid level is avoided.

This design is particularly preferable in the case, when step (iv) comprises a condenser and/or a condenser as well as a downstream membrane gas drying system. In particular in the case of a condenser a liquid level may be present which then can be pumped off.

A particularly advantageous design envisages that this condenser comprises a measuring device which measures the liquid level within the condenser. In addition, in the most preferred variant the process of pumping is controlled or regulated. So, it is avoided that a part of the sample gas is removed from the device by a pumping rate which is too high which would lead to a lowering of the carrier gas flow and in the case of low flows to a peak broadening and a loss of detection sensitivity associated therewith. On the other hand, however, reliably each form of liquid water is continuously removed from the system.

In summary, by this active pumping the operating safety is increased. Preferably, the pumping down of the condenser is realized in combination with a water level sensor which in the case of an unplanned excessive filling initiates a fast draining via a drain valve. In an alternative, the water level sensor may also increase the pumping rate.

Furthermore, it has been shown to be advantageous, when for the membrane gas drying a perfluorinated copolymer is used which preferably as ionic group contains a sulfo group. In this connection, Nafion® is particularly preferable. This results in a complete drying.

In an alternative or in addition, it is furthermore also advantageous, when as inert gas helium is used. This has the advantage that in the case of a downstream mass spectrometry it does not lead to a change of the results.

In connection with the addition of oxygen and/or inert gas into the atomizer already at this point the total mass flow in the system can be controlled by means of the mass flow controller, wherein either one mass flow controller for the total stream of oxygen and/or inert gas or two separate mass flow controllers for oxygen and inert gas may be provided. Through this positioning it is also avoided that liquid water which perhaps may be present accumulates there and destroys the mass flow controller.

Furthermore, the invention also comprises a device with the features of patent claim 9.

The device is in particularly designed for performing a method with the features of claims 1 to 8. Here, each design embodiment of the plant which allows a described variant of the method is conceivable.

Such a device for the determination of the isotope ratio and/or nitrogen in an aqueous solution comprises a reactor for heating the aqueous solution with addition of oxygen to a temperature of higher than 600° C., an introduction device for introducing the aqueous solution into the reactor, a reduction device for reducing the carbon and/or nitrogen compounds which are contained in the sample gas, at least one drying device for the removal of water and an isotope mass spectrometer.

Essential for the invention is that the introduction device is formed by a capillary tube and a pipe which surrounds this tube. Through the capillary tube the mobile phase which contains the sample is introduced and through the pipe a gas mixture of oxygen and/or at least one inert gas is introduced. Preferably, the pipe extends beyond the outlet opening of the capillary tube. By the mixing of gas stream and aqueous mobile phase the last one is atomized. By this atomization the introduction into the system is realized in a substantially more uniform manner. This, on the one hand, prevents a broadening of the peaks in the downstream mass spectrometer and, on the other hand, the development of pressure pulses. In addition, it is favorable, that so via the introduction device in the flow profile a preheating step is provided, because the introduction device extends into the hot zone of the reactor.

In addition, it has been shown to be a preferable variant, when the pipe and/or the capillary tube is/are at least partially manufactured from platinum, because so virtually an oxidation of the introduction device material is completely prevented. In addition, the thermal conductivity may contribute to the advantage that the sample which has to be introduced is already heated in the capillary tube.

In this connection it has been shown to be advantageous, when through an additional, at least partial jacket a purging region surrounding the pipe is formed through which during operation a purging gas which is identical with or different from the atomizer gas mixture which is preferably also composed of oxygen and/or inert gas is introduced. This purging region prevents the formation of a dead volume.

Furthermore, it has been shown to be advantageous, when the reactor is at least partially, preferably completely filled with silver wool. So, within the reactor a more homogenous temperature profile is generated. At the same time, the silver wool offers a considerably enlarged surface for the aerosol from the atomization which partially deposits there so that also here the reaction may proceed more completely.

In addition or in an alternative, it is furthermore recommended to use upstream with respect to the reactor a liquid chromatography, preferably an HPLC, in which via its at least one column a sample to be examined can be separated into its single constituents.

Further features, advantages and application possibilities of the invention also follow from the subsequent description of the figures. Here, all described and/or depicted features form on its own or in arbitrary combination the subject matter of the invention, independently of their summary in the patent claims or their back references.

Shown are in:

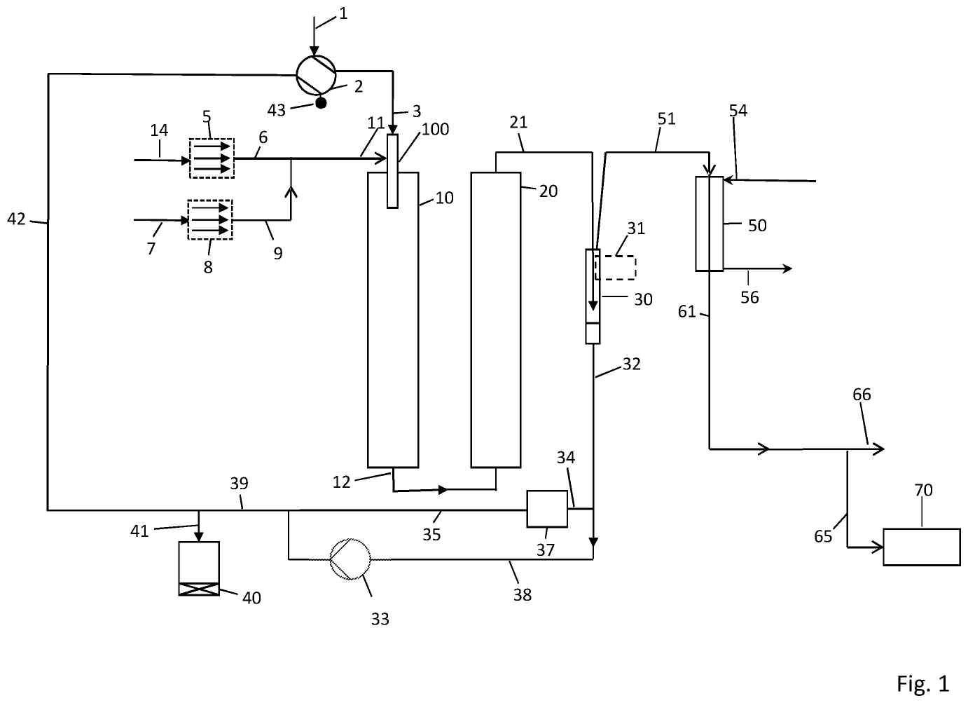

FIG. 1 the schematic illustration of the measuring device according to the present invention and in

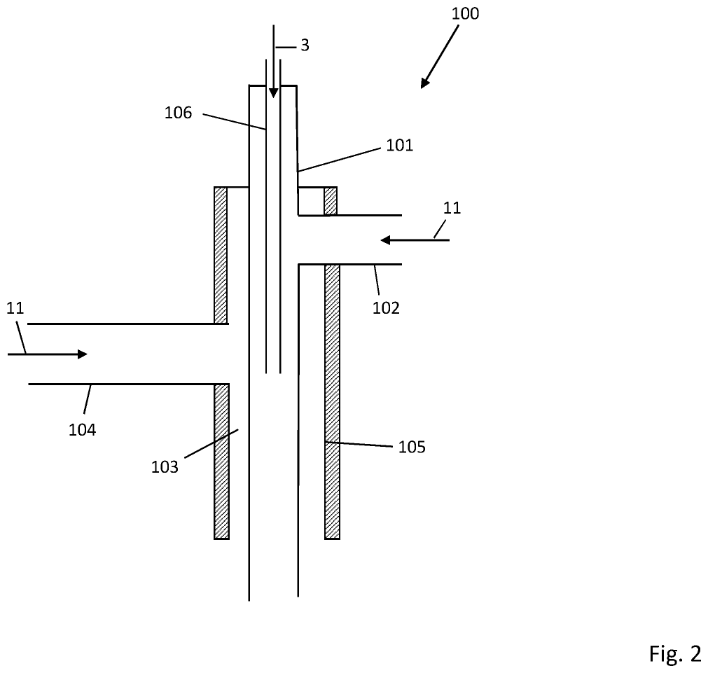

FIG. 2 the introduction device according to the present invention in detail.

Thus, FIG. 1 illustrates the interconnection of the different components of the measuring device. Via line 1 a liquid sample, preferably from an HPLC, in an aqueous mobile phase is loaded into a four-way valve 2. This one can either discard the liquid sample by an interconnection via lines 42 and 41 in a collecting container 40 or can guide the sample via line 3 to an introduction device 100 which is here not shown in detail.

In this introduction device the sample is mixed with an inert gas, preferably helium, which is guided via a line 11, a mass flow controller 5, a line 6 and/or with oxygen which is preferably guided via a line 7, a mass flow controller 8 in line 9. Optionally, inert gas and oxygen can also at least partially be introduced via a common line 11. In each case, the liquid sample exits line 3 and in atomized form enters a reactor 10.

From reactor 10 via a line 12 the completely evaporated, water containing sample is transferred in a reduction device 20 in which the contained components, especially the carbon and nitrogen compounds, are reduced.

Via a line 21 the so treated sample gas together with the water vapor is introduced into the condenser 30. This condenser 30 preferably comprises a liquid measuring sensor 31 which controls/regulates the liquid level in the condenser 30. So, condensed water is pumped off via the lines 32 and 38 as well as a pump 33 in a controlled or regulated manner. Via a bypass connection with the components 34, 35 and 37 this water can also be guided into the collecting container 40 so that it is guaranteed that also in the case of very large amounts of water this water does not remain in the system.

Then, via a line 51 the sample can be fed into a drying device 50 for complete drying which is particularly preferably conducted with Nafion®. In this case, via a line 54 an inert gas, also preferably helium, is introduced and is again removed via a line 56.

Finally, via a line 61 the so prepared sample gas is fed into a line 65 and then into a mass spectrometer 70. Via a line 66 it is also possible to discard the sample or to discharge redundant sample amount/carrier gas.

FIG. 2 shows in detail once again the introduction device 100 according to the present invention. The introduction device 100 comprises a first capillary tube 106 into which, preferably from above, via line 3 liquid sample in a mobile phase is introduced, the flow of which is favorably realized in a continuous manner.

This capillary tube 106 is jacketed by a pipe 101. Favorably, the pipe 101 extends beyond the length of the capillary tube 106. It is conceivable that the geometry of the pipe 106 in the region of the outlet opening of the capillary tube 106 changes in a manner which is not shown.

Via a line 11 at a connecting piece 102 which opens out into the pipe 101, for example in an orthogonal direction, oxygen and/or inert gas are admixed so that in the further course of capillary tube 106 and pipe 101 in the region of the outlet opening of the capillary tube 106 the sample is atomized.

Preferable is a design in which the pipe 106 is jacketed by a cylinder 105. So, a purging region 103 is formed around the pipe 101. The purging region 103 comprises a second connecting piece 104 which is preferably arranged in orthogonal direction and into which via line 11 or in an alternative via another source also oxygen and/or inert gas are fed.

### LIST OF REFERENCE SIGNS

1 line

2 four-way valve

3 line

5 mass flow controller

6, 7 line

8 mass flow controller

9 line

10 reactor

11, 12 line

20 reduction device

21 line

30 condenser

31 liquid level controller

32 line

33 pump

34, 35 line

37 valve

38 line

40 collecting container

41, 42 line

43 plug

50 drying device

51 line

56 line

57 valve

58, 61 line

65, 66 line

70 mass spectrometer

100 introduction device

101 pipe

102 connecting piece

103 purging region

104 connecting piece

105 cylinder

106 capillary tube

1. A method for the determination of the isotope ratio of carbon and/or nitrogen in an aqueous mobile phase containing a sample, comprising the following steps
(i) introduction of the aqueous mobile phase into a reactor,
(ii) heating of the aqueous mobile phase with addition of oxygen in the reactor to a temperature of higher than 600° C. for the formation of a water containing sample gas,
(iii) reduction of the nitrogen oxides being present in the sample gas as well as removal of the contained oxygen,
(iv) removal of the water from the sample gas by chemical drying and/or membrane gas drying,
(v) introduction of the dried sample gas into an isotope mass spectrometer,
wherein the introduction in step (i) is realized by introducing the aqueous mobile phase in a capillary tube which leads into the reactor with a gas mixture of oxygen and at least one inert gas, and
wherein the mass flow of oxygen and inert gas is regulated or controlled by at least one mass flow controller which is upstream with respect to the introduction and that after step (iv) removed water is actively pumped off.

2. The method according to claim 1, wherein the step (iv) comprises a condenser and/or a membrane gas drying system which is downstream with respect to the condenser.

3. The method according to claim 3, wherein the condenser comprises a measuring device for the determination of the liquid level.

4. The method according to claim 4, wherein on the basis of the measured data of the liquid level the pumping is controlled or regulated.

5. The method according to claim 1, wherein for the membrane gas drying a perfluorinated copolymer containing a sulfo group as ionic group is used.

6. The method according to claim 1, wherein as inert gas helium is used.

7. The method according to claim 1, wherein via the addition of oxygen and/or inert gas into the atomizer the total mass flow in the system is controlled or regulated with at least one mass flow controller.

8. A device for the determination of the isotope ratio of carbon and/or nitrogen in an aqueous mobile phase containing a sample, comprising:
an introduction device (100) for the introduction of the aqueous mobile phase into a reactor (10), the reactor (10) for heating the aqueous mobile phase to a temperature of higher than 600° C. for the formation of a sample gas,
a reduction device (20) for the reduction of carbon and/or nitrogen compounds which are contained in the sample gas,
at least one drying device (30, 40) for the removal of water and an isotope mass spectrometer (70),
wherein the introduction device (100) is formed by at least one capillary tube (106) which is jacketed by a pipe (101), wherein through the capillary tube (106) the aqueous mobile phase and through the pipe (101) a gas mixture of oxygen and/or at least one inert gas are introduced.

9. The device according to claim 8, wherein the pipe (101) is at least partially jacketed by a cylinder (105).

10. The device according to claim 8, wherein through the purging region (103) between pipe (101) and cylinder (105) during operation a purging gas which is identical with or different from the atomizer gas mixture is guided.

11. The device according to claim 8, wherein the pipe (101) and/or the capillary tube (106) is/are manufactured from platinum.

12. The device according to claim 8, wherein the reactor (10) is filled with a silver wool.

13. The device according to claim 8, wherein a liquid chromatography is upstream with respect to the reactor (10).
